(19) United States
(12) Patent Application Publication
(10) Pub. No.: US 2015/0149338 A1
(43) Pub. Date: May 28, 2015

(54) SYSTEM AND METHOD FOR INDEXING, MONITORING, AND INVENTORYING DIGITAL ASSETS

(71) Applicant: CAPSOOLE, INC., Campbell, CA (US)

(72) Inventors: Ayelet HIRSHFELD, Campbell, CA (US); Jennifer MITCHELL, Los Altos, CA (US); Liat GENOSAR-ROTH, Sunnyvale, CA (US); Eran LESHEM, Cupertino, CA (US)

(21) Appl. No.: 14/554,657

(22) Filed: Nov. 26, 2014

Related U.S. Application Data
(60) Provisional application No. 61/909,427, filed on Nov. 27, 2013.

(51) Int. Cl. G06Q 40/00; G06Q 50/00

(52) U.S. Cl. CPC G06Q 40/00; G06Q 50/01
USPC 705/35

(57) ABSTRACT

Method(s), system(s), apparatus(es), and computer program products are provided that can index, monitor, inventory, and/or monetize digital assets, such as documents, photographs, videos, blogs, online accounts, social media accounts, e-mail accounts, online banking accounts, etc.

### CROSS-REFERENCE TO RELATED APPLICATIONS

This application claims priority from U.S. Provisional Application No. 61/909,427, filed on Nov. 27, 2013. The entire contents of this earlier filed application are hereby incorporated by reference in their entirety.

### BACKGROUND

1. Field

Some embodiments of the invention generally relate to computer systems and particularly to computer systems that, for example, provide services for indexing, monitoring, inventorying, and/or monetizing digital assets or on-line accounts, such as but not limited to email accounts, social network accounts, on-line bank accounts, electronic commerce accounts, and/or any digital or electronic account associated with tangible or intangible assets.

2. Description of the Related Art

People and organization's lives are increasingly more digital, for example, as individuals and businesses spend more time interacting on-line, and storing personal information and their digital assets on local drives or cloud servers. For instance, an individual will likely communicate with friends and family using email services, will create online personas using social network services, will engage in electronic commerce transactions using electronic commerce services, and engage in other digital services. Similarly, an increasing number of businesses rely on cloud computing to provide and receive various services. In order to utilize such digital services, a user must provide information to various digital service providers, such as a name, email address, physical address, password, and credit card number. In addition, the user may provide other types of information, such as documents, images, and other electronic files, to the digital service providers, with the purpose of sharing the information with other individuals, using one or more digital services. The amount of information provided to digital service providers can be vast and valuable, due to the number of digital service providers that a user (e.g., organization or individual) can interact with, due to the amount of the information a user may be required (or may desire) to provide to each digital service provider, as well as the type and nature of information shared. Management and monitoring of this vast and potentially valuable amount of information can be extremely challenging to an individual, as there is generally no central mechanism for managing such a large amount of information. Further, such information is generally retained by the digital service providers, and can be vulnerable to mining and exploitation.

### SUMMARY

One embodiment is directed to a method that may include receiving, by a device comprising a processor, digital asset information and/or online account information from a user. The method may further include indexing and creating an inventory of digital assets and online accounts based on the received digital asset information and/or online account information, and evaluating the inventory of the digital asset information and/or online account information based on a set of rules to calculate a value for each of the digital assets and/or online accounts.

Another embodiment is directed to an apparatus that may include at least one processor and at least one memory comprising computer program code. The at least one processor and at least one memory are configured to control the apparatus to receive digital asset information and/or online account information from a user, index and create an inventory of digital assets and online accounts based on the received digital asset information and/or online account information, and evaluate the inventory of the digital asset information and/or online account information based on a set of rules to calculate a value for each of the digital assets and/or online accounts.

In one embodiment, the method further comprises calculating a cost for insuring the digital assets and online accounts based on each of the calculated values. According to an embodiment, the set of rules comprises a rule for calculating a value of a social media account of the user, and the rule for calculating the value of the social media account of the user comprises the following equation: ValueSocial=((Post+Re-Post+comment+Like)*Friends)*‘Unit Base Price’.

In an embodiment, the set of rules comprises a rule for calculating a value of online assets with a known monetary value, and the rule for calculating the value of the online assets with a known monetary value comprises the following equation: ValueDigAssest=sum(purchased items).

According to an embodiment, the set of rules comprises a rule for calculating a value of the user's visits to certain locations, and the rule for calculating the value of the user's visits to certain locations comprises the following equation: ValueLocation=sum(Check-ins)*‘unit price’+(Offline History points)*‘unit price’+Real-Time*‘Unit Price’.

In an embodiment, the set of rules comprises a rule for calculating a value of the user's purchase history, and the rule for calculating the value of the user's purchase history comprises the following equation: ValuePurHistory=(Recite Items)*‘item unit value’+(Credit Card Statement)*‘unit price’.

According to an embodiment, the set of rules comprises a rule for calculating a value of written materials produced by the user, and wherein the rule for calculating the value of written materials produced by the user comprises the following equation: ManValue=(Manuscript*Citations*Mentions*Links)*‘unit Price’.

In an embodiment, a total value of the digital assets of the user is calculated by the following equation: Total Digital Asset Value=ValueSocial+ValueDigAssest+ValueLocation+VlaluePurHistory+ManValue+DPValue.

Another embodiment is directed to a computer program, embodied on a non-transitory computer readable medium, the computer program configured to control a processor to perform a process. The process may include receiving digital asset information and/or online account information from a user, indexing and creating an inventory of digital assets and online accounts based on the received digital asset information and/or online account information, and evaluating the inventory of the digital asset information and/or online account information based on a set of rules to calculate a value for each of the digital assets and/or online accounts.

### BRIEF DESCRIPTION OF THE DRAWINGS

For proper understanding of the invention, reference should be made to the accompanying drawings, wherein:

FIG. 1a illustrates a block diagram of a system, according to an embodiment;

FIG. 1b illustrates a block diagram of an apparatus, according to an embodiment; and

FIG. 2 illustrates a flow diagram of a method, according to an embodiment.

### DETAILED DESCRIPTION

It will be readily understood that the components of the present invention, as generally described and illustrated in the figures herein, may be arranged and designed in a wide variety of different configurations. Thus, the following detailed description of the embodiments of a method, apparatus, system, and computer-readable medium, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments.

A “computer” or “device” as understood by one of ordinary skill in the art, is any programmable machine that receives input, automatically stores and manipulates data, and provides output. A “computer program” is any sequence of instructions written to perform a specific task on a computer, and has an executable form that a computer (typically through the use of a processor) can use to execute the instructions. A “computer module,” “software module,” or “module” is any computer program, or a portion thereof, that encapsulates related functions. A “computer application,” “software application,” or “application” is any collection of computer programs and/or modules. A “computer network” or “network” is any collection of computers interconnected by communication channels that facilitate communication among the computers.

In addition, a “service” or “web service,” as understood by one of ordinary skill in the art, is a module or application designed to support interoperable computer-to-computer interaction over a network. A service can have an interface described in a computer-processable format. A computer can interact with a service by sending messages over a network protocol. Examples of services are Big Web services and RESTful services. Big Web services are services that follow a Simple Object Access Protocol (SOAP) standard and use Extensible Markup Language (XML) messages. RESTful services are services that utilize a Representational State Transfer (REST) style of software architecture, where clients are separate from servers by a uniform interface.

Furthermore, a “server” is an example of a computer that includes a computer program or module whose instructions serve requests of other computer programs, such as performing computation tasks on behalf of other computer programs. The term “server” can alternatively refer to the computer program or module that is executed on the computer. A “client” is an example of a computer that includes a computer program or module whose instructions access one or more services made available by a server. The term “client” can also alternatively refer to the computer program or module that is executed on the computer.

According to an embodiment, method(s), system(s), apparatus(es), and computer program products are provided that can index, monitor, inventory, and/or monetize digital assets.

Digital assets according to certain embodiments may include, but are not limited to, files, documents, media, applications, and/or accounts that are created, owned, or previously purchased by an organization or individual. Some examples of digital assets may include written documents stored in any electronic or digital file, images, photos, audio, video, and/or multimedia files that are created, purchased, owned, or otherwise in possession of a user, as well as tangible and intangible items that were purchased or obtained electronically or digitally. This would include, for example, digitized publications that can be any work created and placed by the user on a web platform including, but not limited to, any texts such as blogs, reports, reviews, and media such as YouTube™ videos, presentations, lectures, electronic teaching instruments, etc.

Other examples of digital assets may include online accounts, such as e-mail accounts, e-commerce accounts (e.g., Amazon™, iTunes™, etc.), online banking accounts, social media accounts (e.g., Facebook™, Twitter™, LinkedIn™, etc.), stock trading accounts, as well as storage (e.g., cloud) accounts, or any account that may be tied to an organization, individual or asset, such as medical records or cord blood registry.

Digital assets may be divided into several categories including, but not limited to, (1) tangible assets with a digital footprint, (2) intangible assets that have known monetary value, or (3) intangible assets that have no known monetary value. These are collectively referred to herein as digital assets.

Tangible assets with a digital footprint may be retrieved, for example, via a user's purchase history with an online retailer, and/or via uploading images of real assets and determining the monetary value by uploading the image to an image search engine.

Intangible assets with a known monetary value may include, for example, an electronic book library purchase history (e.g., Amazon™ library), online music library purchase history (e.g., iTunes™, where the value is number of songs multiplied by their dollar value), online videos uploaded to video sharing sites (e.g., YouTube™ videos, where the value may be determined based on number of downloads, number of liked videos, number of subscribers, number of views, number of shares, etc.), or published books/manuscripts.

Intangible assets with no known monetary value may include, for example, uploaded pictures to image sharing sites (e.g., Picasa™, Instagram™, Foursquare™), social media accounts, or a user's search or web history. For instance, for a user's uploaded pictures, a monetary value may be calculated based on an influence type index (e.g., a Klout™ score) which measures the social impact and outreach (celebrities will have higher estimated monetary value), by calculating the outreach of one's pictures with crawlers that retrieve the assets (e.g., via image search engine), and allowing user's to claim royalties based on owner's copyright.

For social media accounts, embodiments may factor a user's outreach and social impact (e.g., as measured by Klout™ score or other similar indexes). The outreach of a person may assume a monetary value once companies start paying them for advertising and/or in cases where an individual can claim proprietary rights e.g., retrieve their digital footprint via crawlers and demand royalties.

A user's search or web history can be sold to marketing companies in order for them to use targeted marketing. This makes one's web history (including GPS routes, credit and debit card statements, shops visited, items purchased online or offline, etc.) take on a monetary value.

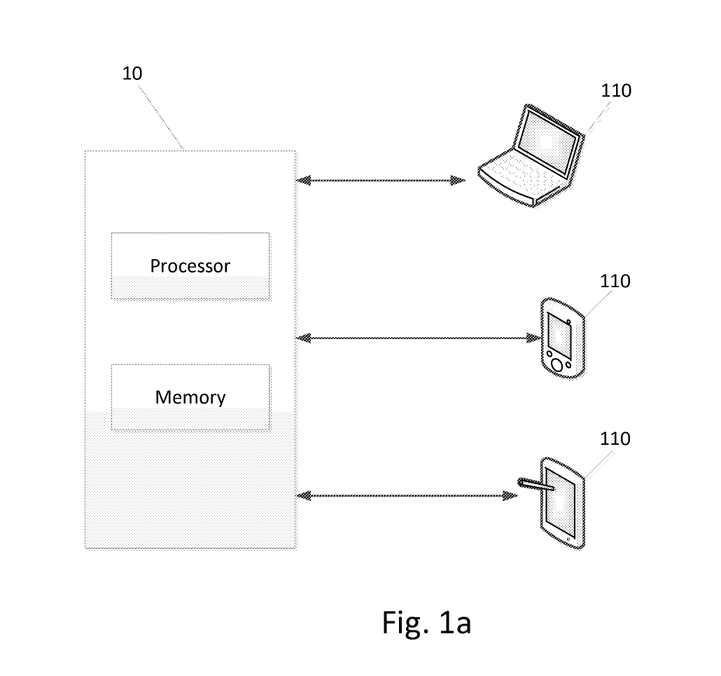

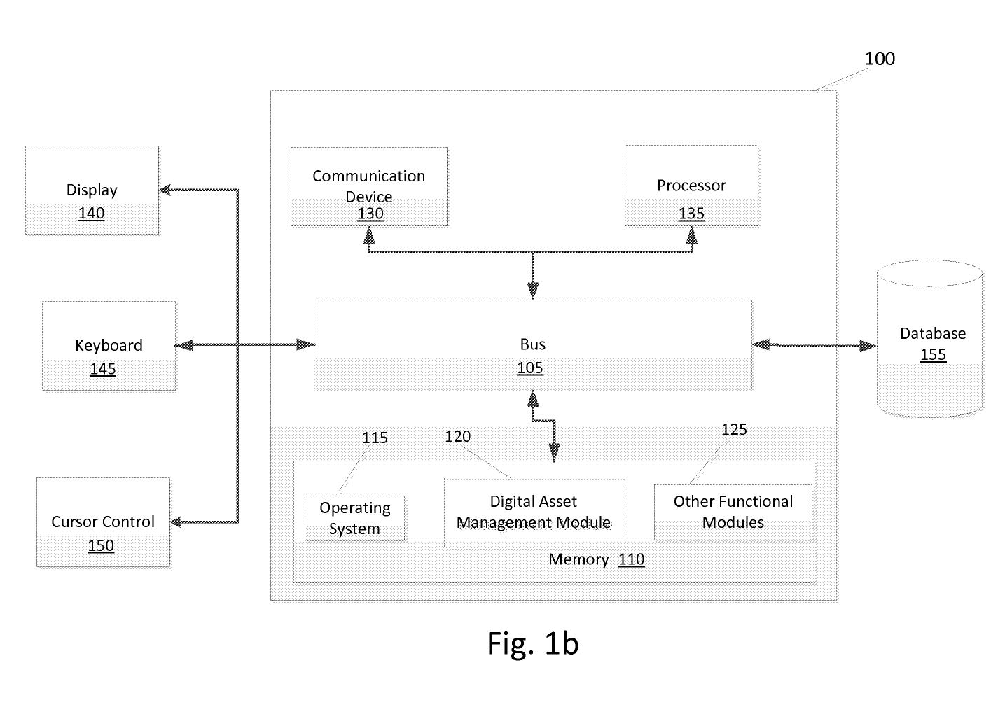

A system 10, according to one embodiment as illustrated in FIG. 1a, is configured to receive, from a user/user device/associated server 110, digital asset information, such as files, documents, media, and applications, and/or online account information and external service credentials used to login to those accounts. This may include receiving access to all locations where digital assets are stored (e.g., local drive, internet drives such as Dropbox™, Google™ drive, Picasa™, Amazon™, iTunes™, email accounts, etc.). In some embodiments, the system 10 may be configured to retrieve the digital assets automatically. For example, the system 10 may be configured to employ crawlers to proactively retrieve assets according to a predefined set of conditions (e.g., matching images, files, etc.). The system 10 may then be configured to index and perform an inventory of all digital assets. As depicted in FIG. 1a system 10 may include at least a processor and memory, as well as other components, devices, and modules to aid in its functionality, such as a transceiver, detector, calculator, etc., which are not shown.

According to an embodiment, the system 10 is configured to assign each digital asset of a respective user with the same authentication code (i.e., a user specific authentication code). Once the system creates an inventory of digital assets, the inventory of digital assets may be indexed on an ongoing basis and analytics can be provided to allow the user to continuously and accurately track/monitor their entire digital asset inventory without losing track. In an embodiment, the system is configured to evaluate the inventory based on a set of rules that determine the value of each of the digital assets in the inventory. For example, in an embodiment, the rules that determine the value may combine any real/actual monetary value of an asset with the perceived emotional value of the asset to reach a determination of the value of the asset. In certain embodiments, the system 10 can also be used to provide a price comparison for the storage of different assets (i.e., price per MB or GB of data storage). In addition, according to some embodiments, the system 10 may be configured to calculate a price for insuring the digital assets depending on the determined value of each of the digital assets in the inventory.

In view of the above, according to some embodiments, the system 10 may be configured to track any shared digital assets including those with a known monetary value, such as iTunes™, Amazon™ (Kindle™, music, movies), Google™ play, as well as any images (public, private, those with a sentimental value, depicting a work of art, etc.), videos (YouTube™, etc.), articles, publications including any intellectual property such as language, spreadsheets, presentations, Bank Account statements (e.g., traditional savings or checking accounts, PayPal™, 401K accounts, E*TRADE™, etc.), digital presence (LinkedIn™, Facebook™, Twitter™, Yahoo™, Reddit™), as well as any private data which is digitized, professional literature, and requests a confirmation of ownership from the user. In case the user is the owner, the system 10 can provide analytics to determine and inform the user where the digital asset has been deployed across the web so that the user can track it and claim ownership.

As mentioned above, in an embodiment, the system 10 is configured to provide analytics that allow the user to continuously and accurately track their entire digital asset inventory. These analytics may result in information including the number of people that have visited your profile/account per day, how many people have viewed, read, shared, bookmarked, and/or pinned a post, file, document, article, video, etc; the number of hits received by each of the user's digital assets, passing of an ownership per video etc. Additionally, embodiments can also monitor the activity for any digital assets which may already have an associated monetary value, such as a YouTube™ channel, so that they can be added to the user's “digital bank/safe” to allow future valuation.

As outlined above, according to certain embodiments, the system 10 may enable the tracking and calculating the perceived monetary value of users' digital assets, including the user's digital library and online presence across social platforms. For example, for a Facebook™ profile, the calculation of monetary value may take into account the number of friends, number/quality of posts, and other levels of activity on a user's page. For LinkedIn™, the calculation may take into account the number of hits per shared article, daily number of profile views, number of contacts, and/or global network reach. For Twitter™, the calculation may take into account the number of followers, the number of retweets, the number of clicks on tweeted links, etc. For Instagram™, the calculation may take into account the number of followers, the number of clicks on posted photographs, etc. For Pinterest™, the calculation may take into account the number of pins, number of followers, etc. For blogs, the calculation may for instance take the form of: the number of articles x number of followers x number of reads x number of comments. In some embodiments, each of the parameters may be given a weight.

As suggested above, according to certain embodiments, the system 10 can collect and compile a user's digital assets and digital being/presence, and will allow indexing of the user's “digital bank”. This “digital bank” may be considered, for example, a file library (classification system) that can be used/stored within any storage system.

Therefore, according to embodiments, the system 10 may be configured to store and later retrieve a list of one or more user's digitized purchased assets and/or digitized publications. Lists of all those digitized items can be created by accessing user's accounts managed by the system in a central location. Purchased items—for example, iTunes™, Amazon™ or Google Play™ libraries—can be uploaded to a SafeBox. In an embodiment, the system can determine and store the real value for every purchased item—music, video, eBook, application, or tangible items.

For digitized publications, such as a video published on YouTube™ or other online site, the value can be measured by the numbers of times the video is viewed, shared, and/or commented on. This assumes that the video is original, i.e., produced by the user (not a recording of previously produced media). For text items, such as posts on twitter, the value of a tweet may be estimated by the number of followers plus the number of retweets. For other text, such as articles, blogs, journal reports, these may be valuated by the number of followers and comments, and references to those articles (including secondary references). With respect to financial or business accounts (e.g., PayPal, bank accounts), the value is reflected by the balance that this account holds.

According to an embodiment, the system 10 may be configured to generate a monthly balance statement to each user, which may be an organization or individual. The statement can include the net value of the user's digital asset portfolio, as well as an update on the status of each of the digital assets, and any trends, for example. In some embodiments, the system 10 can also provide daily notifications/alerts/updates for each platform or singular asset activity. These daily alerts may be sent to the user via e-mail, text message, or any other appropriate communications medium. Thus, the system 10 can allow for daily continuous traffic updates for the digital asset portfolio.

Accordingly, in an embodiment, the system 10 can track the online presence and digital assets' distribution across a variety of industries and platforms. This will allow an organization as well as its individual subscribers to assess which platforms: “serve me?” “which platforms serve my organization?” This allows the individual and/or organization to glance over their activity across platforms, track, and choose which platforms are of best fit to them and which platforms are worth their time investment.

In addition as mentioned above, embodiments of the system 10 provide an ability to track the location and existence of each of a user's digital life/presence/being/assets. Moreover, the user's unique, personal ID can be provided by the system to allow identifying distribution trends of the user's digital life/presence/being/assets.

Further, according to certain embodiments, the system 10 will allow for the monitoring of the online presence of a user's children (photos shared, etc.). Also, some embodiments may be configured to engrave or etch the user's unique ID (or that of their child's/family's) over all of their images so that they can be more easily tracked.

According to certain embodiments, the system 10 is configured to generate a database that will include links to all the digital assets/being and the metadata surrounding them (including all permutations and information to determine how popular they are).

In addition, embodiments can be implemented as a mobile application which can be accessed via any mobile device thereby allowing a user to view their digital assets' portfolio anywhere and track their assets across platforms in real time.

FIG. 1b illustrates a block diagram of an apparatus 100 (which may be a component or implementation of system 10), according to an embodiment of the invention. In some embodiments, apparatus 100 may be a computer (e.g., microcomputer, a personal computer, a desktop computer, a laptop computer, a notebook computer, a minicomputer, a mainframe computer, a supercomputer, or a workstation), server, tablet, mobile phone or other mobile device, or any other electronic device. Apparatus 100 may include a bus 105 or other communications mechanism for communicating information between components of apparatus 100. Apparatus 100 may also include a processor 135, operatively coupled to bus 105, for processing information and executing instructions or operations. Processor 135 may be any type of general or specific purpose processor.

Apparatus 100 may further include a memory 110 for storing information and instructions to be executed by processor 135. Memory 110 can be comprised of any combination of random access memory (RAM), read only memory (ROM), static storage such as a magnetic or optical disk, or any other type of machine or computer-readable medium. Apparatus 100 may further include a communication device 130, such as a network interface card or other communications interface, to provide access to a network. As a result, a user may interface with apparatus 100 directly, or remotely through a network or any other method. In addition, apparatus 100 may interface with any resources through a network using communication device 130.

A computer-readable medium may be any available medium that can be accessed by processor 135. A computer-readable medium may include both a volatile and nonvolatile medium, a removable and non-removable medium, and a storage medium. A storage medium may include RAM, flash memory, ROM, erasable programmable read-only memory (EPROM), electrically erasable programmable read-only memory (EEPROM), registers, hard disk, a removable disk, a compact disc read-only memory (CD-ROM), or any other form of storage medium known in the art.

Processor 135 can also be operatively coupled, for example via bus 105, to a display 140 or touch screen, for instance. Display 140 can display information to the user. A keyboard 145 and a cursor control device 150, such as a computer mouse, can also be operatively coupled to bus 105 to enable the user to interface with apparatus 100.

According to one embodiment, memory 110 can store software modules that may provide functionality when executed by processor 135. The modules can include an operating system 115, a digital asset management module 120, as well as other functional modules 125. Operating system 115 can provide an operating system functionality for apparatus 100.

Digital asset management module 120 can provide functionality for indexing, monitoring, inventorying, and/or monetizing digital assets. In certain embodiments, digital asset management module 120 can comprise a plurality of modules that each provide specific individual functionality for managing and indexing digital assets. Apparatus 100 can also be part of a larger system. Thus, apparatus 100 can include one or more additional functional modules 125 to include the additional functionality.

Processor 135 can also be operatively coupled via bus 105 to a database 155. Database 155 can store data in an integrated collection of logically-related records or files. Database 155 can be an operational database, an analytical database, a data warehouse, a distributed database, an end-user database, an external database, a navigational database, an in-memory database, a document-oriented database, a real-time database, a relational database, an object-oriented database, or any other database known in the art.

In one embodiment, processor 135 and memory 110 may be configured to control apparatus 100 to receive digital asset information and/or online account information from a user. Processor 135 and memory 110 may be further configured to control apparatus 100 to index and create an inventory of the digital assets and online accounts based on the received digital asset information and/or online account information. Processor 135 and memory 110 may then be configured to control apparatus 100 to evaluate the inventory of the digital asset information and/or online account information based on a set of rules to calculate a value for each of the digital assets and/or online accounts. In some embodiments, processor 135 and memory 110 may be configured to calculate a cost for insuring the digital assets and online accounts based on each of their calculated values.

Embodiments of the invention may be configured to implement the following algorithm(s):

Data Types:
1. Social Network (Facebook, Twitter, WhatsApp, Pintrest,
Instagram, Viber, gmail, *mail, linkedin, Foursquare, quora, etc):
1.1. Post (Twitt, pin)
1.2. Re-Post (retwitt, share, forward, repin)
1.3. Comment (reply, retwitt)
1.4. Like (+1, Love)
1.5. Friends (followers, contacts, influencers) =>’Social Outreach’

| | |
|---|---|
| • | ValueSocial = ((Post + Re-Post + comment + Like) * Friends) |

* ‘,Unit Base Price’

2. Digital Assets with known monetary value (Amazon, iTunes,
Google Play, Barnes & Nobles, etc)
2.1. Digial Books (ebooks)
2.2. Music
2.3. Movies
2.4. Apps

| | |
|---|---|
| • | ValueDigAssest = sum(purchased items) |

3. Location (Waze, Google Maps, Google Location Services,
Facebook, Foursquare, etc)
3.1. Check-in
3.2. Off line location history
3.3. Real-Time location update

| | |
|---|---|
| • | ValueLocation = sum(Check-ins) * ‘unit price’ + (Offline |

History points) * ‘unit price’ + Real-Time * ‘Unit Price’

4. Purchase History (Credit/Debit card statements, Grocery shopping
receipt statements, online retail statements (amazon, costco, target,
etc)
4.1. Recites
4.2. Shops
4.3. Cards

| | |
|---|---|
| • | ValuePurHistory = (Recite Items) * ‘item unit value’ + (Credit |

Card Statement) * ‘unit price’

5. Manuscript (published book, manuscript, composition, plays, etc)
5.1. Manuscript
5.2. Citations
5.3. Mentions
5.4. Links

| | |
|---|---|
| • | ManValue = (Manuscript * Citations * Mentions * Links) * |

‘unit Price’

6. Digital picture
6.1. Digital picture
6.2. Shares
6.3. Links
6.4. Downloads

| | |
|---|---|
| • | DPValue = (DP * Shares * Links * Downloads) * ‘unite Price’ |

Total Digital Asset Value = ValueSocial + ValueDigAssest +
ValueLocation + VlaluePurHistory + ManValue + DPValue

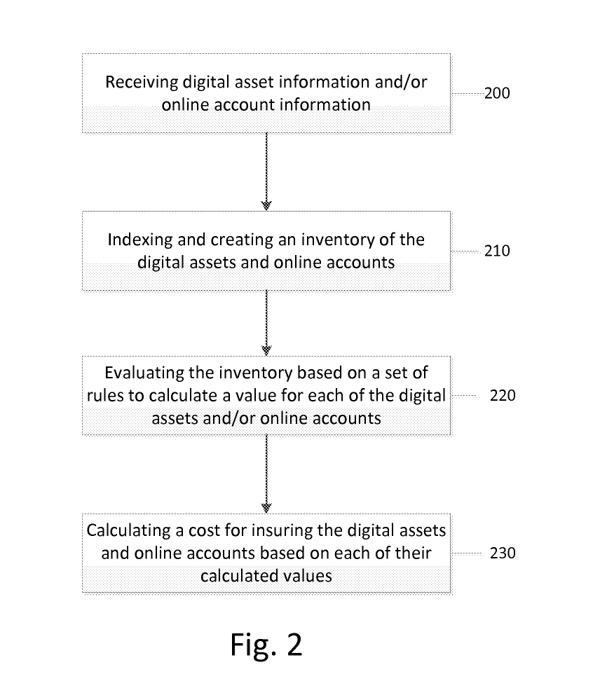

FIG. 2 illustrates a flow diagram of a method of indexing, monitoring, inventorying, and/or monetizing digital assets, according to one embodiment. The method may include, at 200, receiving, for example by a device comprising a processor, digital asset information and/or online account information from a user. The method may then include, at 210, indexing and creating an inventory of the digital assets and online accounts based on the received digital asset information and/or online account information. The method may further include, at 220, evaluating the inventory of the digital assets information and/or online account information based on a set of rules to calculate a value for each of the digital assets and/or online accounts. In some embodiments, the method may include, at 230, calculating a cost for insuring the digital assets and online accounts based on each of their calculated values.

In some embodiments, the functionality of any of the methods described herein, such as that of FIG. 2, may be implemented by software and/or computer program code stored in memory or other computer readable or tangible media, and executed by a processor. In other embodiments, the functionality may be performed by hardware, for example through the use of an application specific integrated circuit (ASIC), a programmable gate array (PGA), a field programmable gate array (FPGA), or any other combination of hardware and software.

The system(s), method(s), apparatus(es), and computer program product(s) discussed above may have several applications. As discussed above, one aspect provides centralization and management of the digital inventory (presence and assets) of a user. In turn, this would allow a user to track their own online presence as well as those of their family members and children. Further, certain embodiments may be used to quantify and monetize a user's digital assets/online presence in order to insure the user's digital assets/online presence against any or certain types of loss or theft. The metadata and analytics for social networks/platforms may be used by individuals or companies to analyze and compare effectiveness of different social mediums and specific advertisements, to quantifying popularity of online users (across platforms) and to help determine or suggest which social platforms are worth the time and investment. In addition, the system described herein can be used to determine compensation for an individual's or organization's advertisement.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

We claim:

1. A method, comprising:
receiving, by a device comprising a processor, digital asset information and/or online account information from a user;
indexing and creating an inventory of digital assets and online accounts based on the received digital asset information and/or online account information; and
evaluating the inventory of the digital asset information and/or online account information based on a set of rules to calculate a value for each of the digital assets and/or online accounts.

2. The method according to claim 1, wherein the method further comprises calculating a cost for insuring the digital assets and online accounts based on each of the calculated values.

3. The method according to claim 1, wherein the set of rules comprises a rule for calculating a value of a social media account of the user, and wherein the rule for calculating the value of the social media account of the user comprises the following equation:
ValueSocial=((Post+Re-Post+comment+Like)*Friends)*‘Unit Base Price’.

4. The method according to claim 3, wherein the set of rules comprises a rule for calculating a value of online assets with a known monetary value, and wherein the rule for calculating the value of the online assets with a known monetary value comprises the following equation:
ValueDigAssest=sum(purchased items).

5. The method according to claim 4, wherein the set of rules comprises a rule for calculating a value of the user's visits to certain locations, wherein the rule for calculating the value of the user's visits to certain locations comprises the following equation:
ValueLocation=sum(Check-ins)*‘unit price’+(Offline History points)*‘unit price’+Real-Time*‘Unit Price’.

6. The method according to claim 5, wherein the set of rules comprises a rule for calculating a value of the user's purchase history, and wherein the rule for calculating the value of the user's purchase history comprises the following equation:
ValuePurHistory=(Recite Items)*‘item unit value’+(Credit Card Statement)*‘unit price’.

7. The method according to claim 6, wherein the set of rules comprises a rule for calculating a value of written materials produced by the user, and wherein the rule for calculating the value of written materials produced by the user comprises the following equation:
ManValue=(Manuscript*Citations*Mentions*Links)*‘unit Price’.

8. The method according to claim 7, wherein a total value of the digital assets of the user is calculated by the following equation:
Total Digital Asset Value=ValueSocial+ValueDigAssest+ValueLocation+VlaluePurHistory+ManValue+DPValue.

9. An apparatus, comprising:
at least one processor; and
at least one memory comprising computer program code,
wherein the at least one processor and at least one memory are configured to control the apparatus to
receive digital asset information and/or online account information from a user;
index and create an inventory of digital assets and online accounts based on the received digital asset information and/or online account information; and
evaluate the inventory of the digital asset information and/or online account information based on a set of rules to calculate a value for each of the digital assets and/or online accounts.

10. The apparatus according to claim 9, wherein the at least one processor and the at least one memory are further configured to control the apparatus to calculate a cost for insuring the digital assets and online accounts based on each of the calculated values.

11. The apparatus according to claim 9, wherein the set of rules comprises a rule for calculating a value of a social media account of the user, and wherein the rule for calculating the value of the social media account of the user comprises the following equation:
ValueSocial=((Post+Re-Post+comment+Like)*Friends)*‘Unit Base Price’.

12. The apparatus according to claim 11, wherein the set of rules comprises a rule for calculating a value of online assets with a known monetary value, and wherein the rule for calculating the value of the online assets with a known monetary value comprises the following equation:
ValueDigAssest=sum(purchased items).

13. The apparatus according to claim 12, wherein the set of rules comprises a rule for calculating a value of the user's visits to certain locations, wherein the rule for calculating the value of the user's visits to certain locations comprises the following equation:
ValueLocation=sum(Check-ins)*‘unit price’+(Offline History points)*‘unit price’+Real-Time*‘Unit Price’.

14. The apparatus according to claim 13, wherein the set of rules comprises a rule for calculating a value of the user's purchase history, and wherein the rule for calculating the value of the user's purchase history comprises the following equation:
ValuePurHistory=(Recite Items)*‘item unit value’+(Credit Card Statement)*‘unit price’.

15. The apparatus according to claim 14, wherein the set of rules comprises a rule for calculating a value of written materials produced by the user, and wherein the rule for calculating the value of written materials produced by the user comprises the following equation:
ManValue=(Manuscript*Citations*Mentions*Links)*‘unit Price’.

16. The apparatus according to claim 15, wherein a total value of the digital assets of the user is calculated by the following equation:
Total Digital Asset Value=ValueSocial+ValueDigAssest+ValueLocation+VlaluePurHistory+ManValue+DPValue.

17. A computer program, embodied on a non-transitory computer readable medium, the computer program configured to control a processor to perform a process, comprising:
receiving digital asset information and/or online account information from a user;
indexing and creating an inventory of digital assets and online accounts based on the received digital asset information and/or online account information; and
evaluating the inventory of the digital asset information and/or online account information based on a set of rules to calculate a value for each of the digital assets and/or online accounts.
